(19) United States
(12) Patent Application Publication
(10) Pub. No.: US 2013/0101125 A1
(43) Pub. Date: Apr. 25, 2013

(54) Acoustic Shock Prevention Apparatus

(71) Applicants: Achim Peters, Jaalil (FI); Anton Nevala, Oulu (FI)

(72) Inventors: Achim Peters, Jaalil (FI); Anton Nevala, Oulu (FI)

(73) Assignee: Nokia Corporation, Espoo (FI)

(21) Appl. No.: 13/808,309

(22) PCT Filed: Jul. 5, 2010
(86) PCT No.: PCT/IB2010/053075

§ 371 Date: Jan. 4, 2013

(51) Int. Cl. H04R 29/00

(52) U.S. Cl. CPC H04R 29/00
USPC 381/56

(57) ABSTRACT

An apparatus including at least one processor and at least one memory including computer program code. The at least one memory and the computer program code is configured to, with the at least one processor, cause the apparatus at least to perform: determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

The present invention relates to apparatus for prevention of acoustic shock in processing of audio signals. The invention further relates to, but is not limited to, apparatus for prevention of acoustic shock in processing audio and speech signals in audio playback devices.

Audio processing and in particular audio processing in mobile devices have been a growing area in recent years.

These mobile devices/portable devices are typically capable of operating or performing several different tasks either subsequently and/or in parallel. For example a mobile device may be capable of performing actions such as, for example, telecommunication playback, audio playback, audio-video playback, audio alert, navigation alert command, radio broadcast playback, and so on. In some circumstances when a use or state of operation of a device is succeeded by a different state where at least the latter state uses the integrated loudspeaker there can be a period of acoustic shock. For example the user could operate the mobile device in a telephone mode which is succeeded by the integrated loudspeaker of the device generating an alert tone, for example to alert the user that there is a further incoming phone call (or a navigational instruction). The difference in sound pressure between the two states could cause a temporary or permanent disturbance of the functioning of the ear, or of the nervous system.

Typically there are no or limited sound pressure limits (for example a sound pressure control set to a maximum sound pressure level to prevent physical damage to the transducer) for operating the integrated handsfree speaker or transducer. In such cases acoustic shock is a problem particularly where the integrated handsfree speaker and earpiece output ports of a mobile device are physically close to each other (for example less than 10 cm apart). This problem increases in devices which use a single speaker solution also known as two-in-one/three-in-one multifunction device integrated handsfree speaker systems. A multifunction device (MFD) is the term typically given to a combined Speaker/EarpieceNibra device. MFD can typically be used as a 2-in-1 or 3-in-1 solution. A 2-in-1 solution is where the MFD is either a Speaker/Earpiece. The 3-in-1 solution is where the MFD is a Speaker/Earpiece/Vibra.

In such single speaker systems the transition from one state or use case to the next when the audio mode is changed from earpiece to integrated handsfree speaker can cause particular severe acoustic shock to the user of the device as the user would have placed the device close to the ear when operation in the earpiece mode. For example a phone call using the earpiece which ends and is followed by a previously paused or subsequently implemented audio MP3 playback mode over the integrated handsfree speaker could result in a sound pressure level differential likely to cause damage to the user.

This, for example, is shown in FIG. 3 whereby the apparatus 10 comprises a first integrated handsfree speaker 119 located near one end of the device 10 (near the microphone region) which produces acoustic waves non-adjacent to the ear 207, an ear piece transducer 120 which is used in earpiece mode audio operation, and a second integrated handsfree speaker 117 near or adjacent to the location of the earpiece 120. In this example the user 251 has just finished an earpiece associated use case or action when the device 10 activates an integrated handsfree use case whereby receives the waveform 201 for the first integrated handsfree speaker 117 and waveform 203 for the second integrated handsfree speaker 119 causes acoustic shock experienced by the user 251.

Many different use case changes could cause acoustic shock for example but not exclusively: a phone call over earpiece mode which then is succeeded by a new alert tone (for example indicating a new incoming call, multimedia message service (MMS) message or short message service (SMS) message received) which is played over the integrated handsfree speaker; a phone call using the earpiece which is succeeded by video playback using audio over the integrated handsfree speaker, a phone call using the earpiece which is succeeded by music playback over the integrated handsfree speaker; a phone call over an earpiece mode is succeeded by FM radio playback over the integrated handsfree speaker; and a phone call over the earpiece mode is succeeded by car navigation commands played over the integrated handsfree speaker.

This invention thus proceeds from the consideration that acoustic shock prevention can be achieved by introducing control mechanisms and monitor use case transitions.

Embodiments of the present invention aim to address the above problem.

There is provided according to a first aspect of the invention a method comprising: determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

Processing the second audio output signal may comprise at least one of: muting the second audio output for a muting time period; and ramping the second audio output for an audio ramp time period.

Ramping the second audio output for an audio ramp time period may comprise at least one of: linear ramping; and non-linear ramping;

Determining a change of state in an apparatus may comprise: determining an ending of the first state, wherein the first state is a member of a first group of states; and determining a start of the second state, wherein the second state is a member of a second group of states.

Each member of the first group of states may operate with the first audio output generated by an earpiece transducer.

The first group of states may comprise at least: telecommunication earpiece audio playback.

Each member of the second group of states may operate with the second audio output generated by an integrated handsfree transducer.

The second group of states may comprise: integrated handsfree speaker alert tone playback; integrated handsfree speaker music playback; integrated handsfree speaker frequency modulation (FM) radio playback; integrated handsfree speaker digital radio such as DAB (Digital Audio Broadcasting) or DRM (Digital Radio Mondiale) playback; integrated handsfree speaker amplitude modulation (AM) radio playback; integrated handsfree speaker navigation command playback; and integrated handsfree speaker video playback.

The method may further comprise: determining the maximum value of the higher average sound pressure level is greater than a threshold value; and wherein processing the second audio output signal further comprises limiting the maximum value of the higher average sound pressure value to the threshold value.

The second state may further operates with a third audio output located physically separate from the first audio output; and processing the third audio output signal such that the third audio output sound pressure level is unchanged.

According to a second aspect of the invention there is provided an apparatus comprising at least one processor and at least one memory, the at least one memory and the computer program code is configured to, with the at least one processor, cause the apparatus at least to perform: determining a change of state in the apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

Processing the second audio output signal may cause the apparatus at least to perform at least one of: muting the second audio output for a muting time period; and ramping the second audio output for an audio ramp time period.

Ramping the second audio output for an audio ramp time period may cause the apparatus at least to perform at least one of: linear ramping; and non-linear ramping.

Determining a change of state may cause the apparatus at least to perform: determining an ending of the first state, wherein the first state is a member of a first group of states; determining a start of the second state, wherein the second state is a member of a second group of states.

Each member of the first group of states may operate with the first audio output generated by an earpiece transducer.

The first group of states may comprise at least: telecommunication earpiece audio playback.

Each member of the second group of states may operate with the second audio output generated by an integrated handsfree transducer.

The second group of states may comprise: integrated handsfree speaker alert tone playback; integrated handsfree speaker music playback; integrated handsfree speaker frequency modulation (FM) radio playback; integrated handsfree speaker digital radio such as DAB (Digital Audio Broadcasting) or DRM (Digital Radio Mondiale) playback; integrated handsfree speaker amplitude modulation (AM) radio playback; integrated handsfree speaker navigation command playback; and integrated handsfree speaker video playback.

The apparatus may be further caused to perform: determining the maximum value of the higher average sound pressure level is greater than a threshold value; and wherein processing the second audio output signal further comprises limiting the maximum value of the higher average sound pressure value to the threshold value.

The second state may further operate with a third audio output located physically separate from the first audio output; and the apparatus may be further caused to perform processing the third audio output signal such that the third audio output sound pressure level is unchanged.

According to a third aspect of the invention there is provided an apparatus comprising: a safety timer configured to generate a first time period; a state determiner configured to determine a change of state in the apparatus within the first time period, wherein a first state operates with a first audio output having a first average sound pressure level and a second state operates with a second audio output having a higher average sound pressure level; and an audio processor configured to process the second audio output signal such that the second audio output sound pressure level is acoustically continuous with respect to the first average sound pressure level immediately following the change of state.

The apparatus may further comprise a muting timer configured to generate a muting time period, wherein the audio processor is configured to mute the second audio output for the muting time period.

The apparatus may further comprise an audio ramp timer configured to generate an audio ramp time period, wherein the audio processor is configured to ramp the second audio output for the audio ramp time period.

The audio processor may be configured to mute the second audio output for the muting time period and ramp the audio output for the audio ramp time period following the muting time period.

The audio processor may comprise a linear ramping amplifier.

The audio processor may comprise a non-linear ramping amplifier.

The state determiner may comprise: a first state determiner configured to determine the first state is a member of a first group of states; and a second state determiner configured to determine the second state is member of a second group of states.

The first group of states may comprise states which operate with the first audio output generated by an earpiece transducer.

The first group of states may comprise at least: telecommunication earpiece audio playback.

The second group of states may comprise states which operate with the second audio output generated by an integrated handsfree transducer.

The second group of states may comprise: integrated handsfree speaker alert tone playback; integrated handsfree speaker music playback; integrated handsfree speaker frequency modulation (FM) radio playback; integrated handsfree speaker digital radio such as DAB (Digital Audio Broadcasting) or DRM (Digital Radio Mondiale) playback; integrated handsfree speaker amplitude modulation (AM) radio playback;integrated handsfree speaker navigation command playback; and integrated handsfree speaker video playback.

The apparatus may comprise a maximum sound pressure level estimator configured to determine the maximum value of the higher average sound pressure level is greater than a threshold value; and the audio processor may comprise a sound pressure level limiter configured to limit the maximum value of the higher average sound pressure value to the threshold value.

The second state may further operate with a third audio output located physically separate from the first audio output; and the audio processor may comprise a unity gain stage configured to pass the third audio output sound pressure level unchanged.

According to a fourth aspect of the invention there is provided a computer-readable medium encoded with instructions that, when executed by a computer perform: determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

According to a fifth aspect of the invention there is provided an apparatus comprising: a timing means for generating a first time period; a state determining means for determining a change of state in the apparatus within the first time period, wherein a first state operates with a first audio output having a first average sound pressure level and a second state operates with a second audio output having a higher average sound pressure level; and an audio processor means for processing the second audio output signal such that the second audio output sound pressure level is acoustically continuous with respect to the first average sound pressure level immediately following the change of state.

The apparatus may further comprise a muting control means for generating a muting time period, wherein the audio processor means is configured to mute the second audio output for the muting time period.

The apparatus may further comprise an ramp control means for generating an audio ramp time period, wherein the audio processor means is configured to ramp the second audio output for the audio ramp time period.

The audio processor means may be configured to mute the second audio output for the muting time period and ramp the audio output for the audio ramp time period following the muting time period.

The audio processor means may comprise a linear ramping amplifier.

The audio processor means may comprise a non-linear ramping amplifier.

The state determiner means may comprise: a first state determiner configured to determine the first state is a member of a first group of states; and a second state determiner configured to determine the second state is member of a second group of states.

The first group of states may comprise states which operate with the first audio output generated by an earpiece transducer.

The first group of states may comprise at least: telecommunication earpiece audio playback.

The second group of states may comprise states which operate with the second audio output generated by an integrated handsfree transducer.

The second group of states may comprise: integrated handsfree speaker alert tone playback; integrated handsfree speaker music playback; integrated handsfree speaker frequency modulation (FM) radio playback; integrated handsfree speaker digital radio such as DAB (Digital Audio Broadcasting) or DRM (Digital Radio Mondiale) playback; integrated handsfree speaker amplitude modulation (AM) radio playback;integrated handsfree speaker navigation command playback; and integrated handsfree speaker video playback.

The apparatus may comprise a sound pressure level estimator means for determining the maximum value of the higher average sound pressure level is greater than a threshold value; and the audio processor means may comprise a sound pressure level limiter configured to limit the maximum value of the higher average sound pressure value to the threshold value.

The second state may further operate with a third audio output located physically separate from the first audio output; and the audio processor means may comprise a unity gain stage configured to pass the third audio output sound pressure level unchanged.

An electronic device may comprise apparatus as described above.

A chipset may comprise apparatus as described above.

### BRIEF DESCRIPTION OF DRAWINGS

For better understanding of the present invention, reference will now be made by way of example to the accompanying drawings in which:

FIG. 1 shows schematically an apparatus employing embodiments of the application;

FIGS. 2a, 2b, and 2c show schematically external views of apparatus suitable for implementing some embodiments of the application;

FIG. 3 shows schematically an example of acoustic shock;

FIG. 4 shows schematically an acoustic shock prevention apparatus according to some embodiments of the application;

FIG. 5 shows operation of the acoustic shock prevention apparatus as shown in FIG. 4 according to some embodiments of the application;

FIG. 6 shows the operation of the acoustic shock prevention apparatus on some audio waveforms; and

FIG. 7 shows schematically an example of acoustic shock prevention.

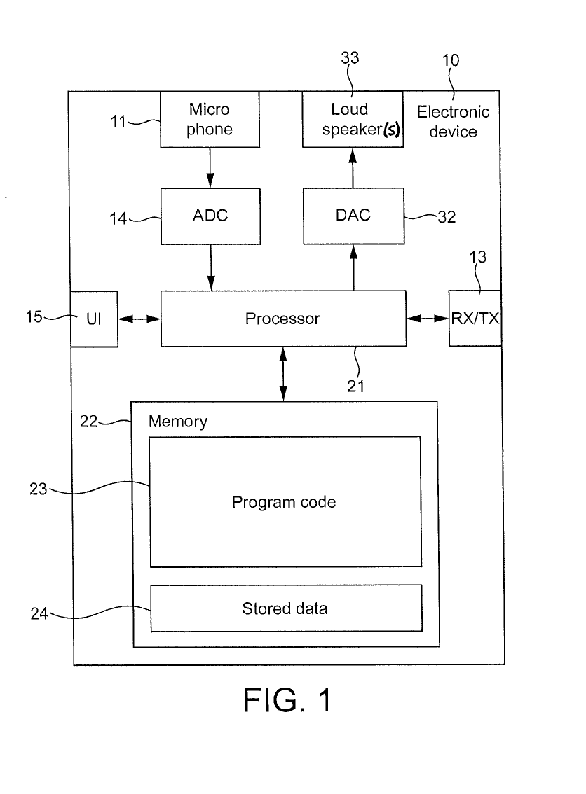

The following describes apparatus and methods for the provision of acoustic shock prevention or mitigation. In this regard reference is first made to FIG. 1 which shows a schematic block diagram of an exemplary electronic device 10 or apparatus, which may incorporate acoustic shock mitigation/prevention apparatus according to some embodiments of the application.

The apparatus 10 may for example be a mobile terminal or user equipment for a wireless communication system. In other embodiments the electronic device may be an audio player such as an mp3 player, or media player such as an mp4player.

The apparatus 10 comprises a processor 21 which may be linked via a digital-to-analogue converter 32 to a playback speaker system 33 configured to provide a suitable audio playback. The playback speaker system 33 in some embodiments can comprise at least one suitable loudspeaker or transducer configured to operate in an earpiece mode. In other words generating acoustic waves suitable when the apparatus is located adjacent to or in contact with the ear. Furthermore at least one of the at least one loudspeaker is configured to operate in an integrated handsfree (IHF) mode. In other words suitable for generating acoustic waves when the apparatus is used when the apparatus is not in close proximity to the ear. In some embodiments the playback speaker can further be a headphone or ear worn speaker (EWS) set. In some embodiments the apparatus 10 may comprise a headphone connector for receiving a headphone or headset. The processor 21 is in some embodiments further linked to a transceiver (TX/RX) 13, to a user interface (UI) 15 and to a memory 22.

The processor 21 may be configured to execute various program codes. The implemented program codes in such embodiments comprise an acoustic shock prevention code or codes. The implemented program codes 23 in some embodiments can be stored for example in the memory 22 for retrieval by the processor 21 whenever needed. The memory 22 could further provide a section 24 for storing data, for example data that has been processed in accordance with the embodiments.

The acoustic shock prevention code or operations can in some embodiments be implemented in hardware or firmware. In the following example a schematic hardware implementation is described however it would be understood that various program codes, stored for example in memory 22, can also implement the acoustic shock prevention operations.

The user interface 15 in some embodiments enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

The apparatus 10 can in some embodiments further comprise at least one microphone 11 for monitoring audio or speech. The apparatus 10 in such embodiments may further comprise an analogue-to-digital converter 14 configured to convert the input analogue audio signal into a digital audio signal and provide the digital audio signal to the processor 21.

The apparatus 10 can in some embodiments receive a bit stream via the transceiver 13. The processor 21 in these embodiments may process the received audio signal data, and output the audio.

In some embodiments the headphone connector can be configured to communicate to a headphone set or earplugs wirelessly, for example by a Bluetooth profile, or using a conventional wired connection.

The received stereo audio data can in some embodiments also be stored, instead of presented immediately, in the data section 24 of the memory 22, for instance for later presentation or forwarding to still another electronic device.

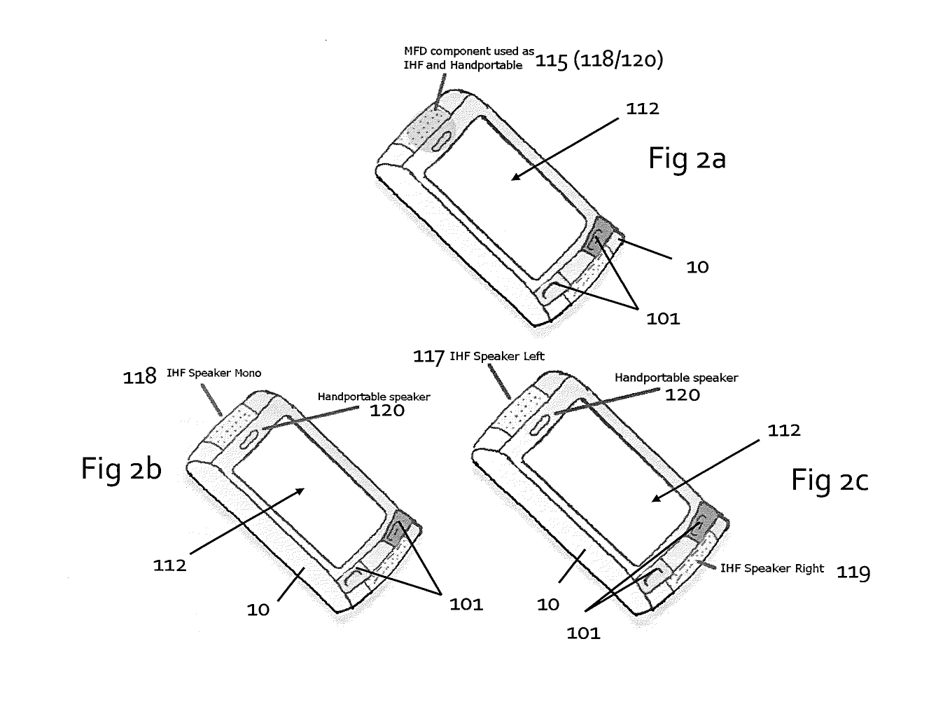

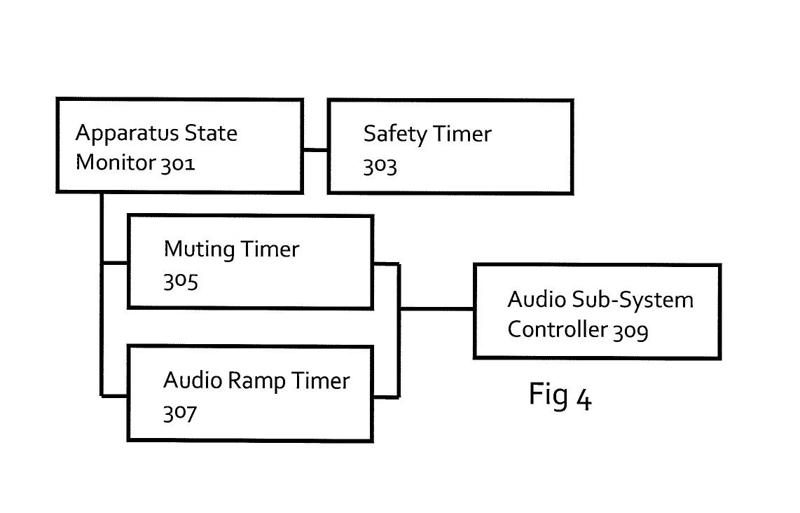

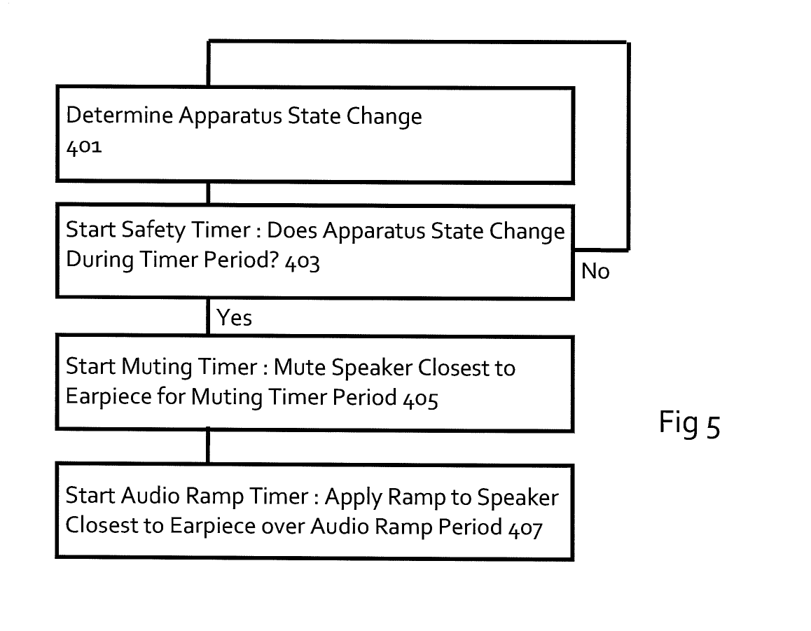

It would be appreciated that the schematic structures described in FIGS. 2a, 2b, 2c and 4 and the method steps shown in FIG. 5 represent only a part of the operation of an apparatus suitable for implementing the functionality of the complete device.

With respect to FIG. 2a, an external view of a first example of apparatus suitable for implementing embodiments of the application is shown. The apparatus 10 is shown with a display screen 112 which in some embodiments is suitable for providing user interface input and display capabilities and further configured to be connected to the processor which in some embodiments controls both displaying information using the display screen 112 and determines when input to the device 10 has been made using the display screen 112. The device 10 further comprises in some embodiments physical buttons 101 suitable for providing a physical user interface experience such as making and ending a telephone call. The device 10 in some embodiments as shown in FIG. 2a can further comprise a multifunction device component 115. The multifunction device component 115 can for example be used both as an integrated handsfree (IHF) speaker 118 and earpiece speaker 120.

With respect to FIG. 2b an external view of a further example device or apparatus 10 suitable for implementing embodiments is shown. In this second example the multifunction device 115 as shown in FIG. 2a is replaced by a separate but physically closely located mono-channel integrated handsfree speaker 118 suitable for providing an audio output for handsfree operations and an earpiece speaker 120 suitable for providing outputs via an earpiece port to the user.

With respect to FIG. 2c an external view of a third example apparatus 10 is shown. In the example shown in FIG. 2c the multifunction device component 115 shown in FIG. 2a is replaced by separate but physically closely located first or left channel integrated handsfree speaker 117 suitable for providing an audio output for handsfree operations as the left audio channel and an earpiece speaker 120 suitable for providing audio output for earpiece operations. Furthermore in the example shown in FIG. 2c, the apparatus or device 10 comprises a second or right channel integrated handsfree (IHF) speaker 119 suitable for providing an audio output for handsfree operations as the right audio channel. Thus the apparatus shown in FIG. 2c is suitable for producing stereo effect audio outputs using the left and right channel integrated handsfree speakers. In other words the example shown in FIG. 2c can output a left channel audio signal via the IHF left speaker 117 and a right channel audio signal via the right IHF speaker 119.

With respect to FIG. 4 an acoustic shock prevention apparatus according to some embodiments is shown in further detail. The operation of the acoustic shock prevention apparatus according to these embodiments is furthermore described with respect to FIG. 5. It would be appreciated that in some embodiments the operations performed by the acoustic shock prevention apparatus as described in the following sections could be implemented at least partially as code operations, modules or separate programs configured to run on at least one processor and stored in at least one memory as described above. In some other embodiments the operations could be implemented at least partially as separate or partially divided physical hardware components. In some embodiments the operations and components described below can be implemented as firmware elements.

The acoustic shock prevention apparatus in some embodiments comprises an apparatus state monitor 301 which is configured to monitor the current state or mode of operation of the apparatus or device 10. In some embodiments the apparatus state monitor 301, state determiner or suitable state determining means, is capable of determining such modes or states as; earpiece phone call mode, integrated handsfree speaker alert tone mode, music playback over integrated handsfree speaker mode, frequency modulation (FM) radio playback over integrated handsfree speaker mode, integrated handsfree speaker digital radio such as DAB (Digital Audio Broadcasting) or DRM (Digital Radio Mondiale) playback, integrated handsfree speaker amplitude modulation (AM) radio playback, car navigation command output over integrated handsfree speaker mode, and video playback over integrated handsfree speaker mode. In some embodiments the phone state monitor 301 is configured to determine between modes or states dependent on whether that operate an earpiece (or headphone) mode and an integrated handsfree state or mode.

In such embodiments the apparatus state monitor 301 is therefore capable of, or configured to, determine when the apparatus 10 is in an earpiece mode and likely to be located close to the user and when the apparatus 10 is in an integrated handsfree speaker mode and likely to be located at a distance from the user. These modes may be activated or controlled by the processor when the user is using the apparatus 10.

In some embodiments the apparatus state monitor 301 when determining a change in the state or mode of operation of the apparatus 10 such as described above the apparatus state monitor can trigger an output to a safety timer 303. In some embodiments the safety timer 303 is triggered when the phone state monitor 301 determines an earpiece mode or state ending.

In some embodiments the safety timer 303 is triggered when the phone state monitor 301 determines an ending or closing of a mode from a first or ‘watch’ list of modes stored in the memory of the apparatus. This first list of modes in some embodiments can be configured by at least one of the operator, the user or an application or control entity operating the mode. For example in some embodiments an application when being installed on the apparatus can request that the mode be appended to the first list as it is expected that the user will operate the application with the device close to the user.

The determination of the change in the apparatus state is shown in FIG. 5 by step 401.

The acoustic shock prevention apparatus further comprises a safety timer 303 which on receiving a first activation signal from the apparatus state monitor 301 performs a timer operation. In some embodiments the timer operation period can be 2 seconds; however it would be appreciated that the safety timer period can be less than or greater than 2 seconds. The safety timer 303 can be implemented by any suitable timing means for generating a first timing period.

In some embodiments the safety timer operation period can be configurable and be any suitable time. In some embodiments the safety timer operation period can be configured by the user of the device, for example within the settings of the apparatus. In some other embodiments the safety timer operation period can be configured by the manufacturer or operator of the device 10 such that the timer allows sufficient time for the user to remove the apparatus from their ear in order to prevent acoustic shock.

The apparatus state monitor 301 further monitors the state of the apparatus while the safety timer period is active.

The operation of starting the safety timer and continued monitoring of the apparatus state during the safety timer period is shown in step 403.

Where the apparatus state monitor 301 determines that there is an apparatus state change during the timer period the apparatus state monitor 301 can activate the muting timer 305 and the audio ramp timer 307 which provide inputs to the audio subsystem controller 309.

In some embodiments the apparatus state monitor 301 is configured to activate at least one of the muting timer 305 and audio ramp timer 307 when determining an apparatus state change to a state of mode of operation from a second or ‘danger’ list of modes stored in the memory of the apparatus. This second list of modes in some embodiments can be configured by at least one of the operator, the user or an application or control entity operating the mode. For example in some embodiments an application when being installed on the apparatus can request that the mode be appended to the first list as it is expected that the user will operate the application using the integrated handsfree speaker at sound pressure levels capable of causing acoustic shock to the user.

Thus for example when the apparatus state monitor 301 determines an ending of a state or mode of earpiece phone call mode, which can be on the first list and then within the safety time period determines a start of a further call or re-entering the earpiece phone call, which is not on the second list then the apparatus state monitor 301 can maintain monitoring the phone stare to determine when the earpiece phone call mode is ended and re-start the safety timer 303 again.

Where the safety timer period expires without the apparatus state monitor 301 determining an apparatus state change (or state that occurs on the second list) the apparatus state monitor 301 can maintain monitoring the phone state to determine a suitable state end to start the safety timer again. In other words as shown in FIG. 5 the operation passes back to step 401.

The acoustic shock prevention apparatus furthermore in some embodiments comprises a muting timer 305 configured to provide a signal over a defined or configurable period to an audio subsystem controller. In other words the apparatus may comprise a muting control means configured to generate a muting time period which defines a time period for an audio subsystem controller 309 to process and mute the audio output over. The muting timer 305 on receiving an activation signal from the apparatus state monitor 301 in some embodiments provides the signal output to the audio subsystem controller 309 as an interrupt signal controlling the audio subsystem controller 309 to mute the integrated handsfree speaker closest to the earpiece for the muting timer period.

The acoustic shock prevention apparatus in some embodiments comprises an audio subsystem controller 309 which is configured to receive output audio signals to be presented to the user via the earpieces, headsets and integrated handsfree speaker or speakers. In other words the apparatus can comprise an audio processor means for processing the audio signal, for example to mute the audio signal over the period defined by the muting control means. The audio subsystem controller 309 in some embodiments can be a gain stage of an audio subsystem controlled via a series of inputs such as a muting timer input and an audio ramp timer input. The audio subsystem controller 309 on receiving a muting timer input can set the audio subsystem gain value to 0, in other words mute the signal to be output by the integrated handsfree speaker. In some embodiments the audio subsystem 309 is configured to mute the signal to be output by the integrated handsfree speaker closest to the earpiece speaker for the time period defined by the muting timer 305. In some embodiments where the apparatus comprises more than one earpiece speaker the audio subsystem 309 can determine which of the earpiece speakers is the closest to the user. For example in some embodiments the apparatus can further comprise a proximity sensor located by each of the earpiece speakers and capable of providing the audio subsystem 309 with the information required to mute the integrated handsfree speaker closest to the earpiece which had been used.

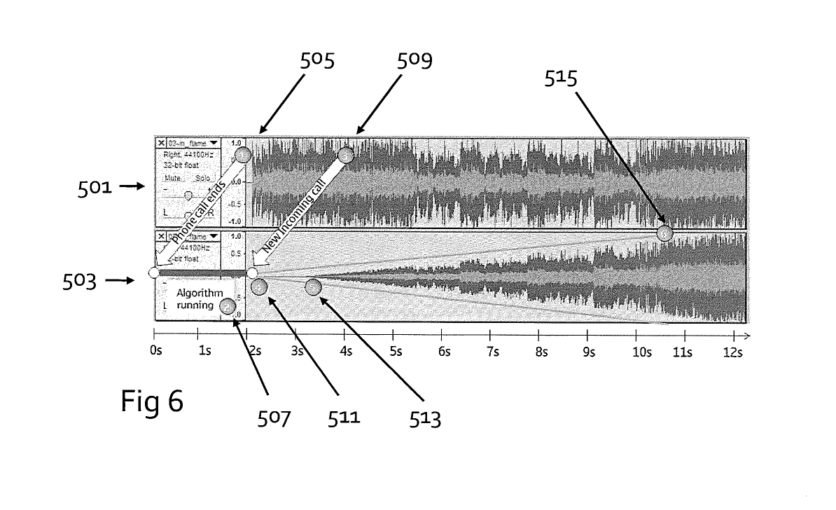

The muting time period generated by the muting timer 305 can be any suitable timer period. For example as shown in FIG. 6 a muting time period can be approximately 1.5 seconds. In some embodiments the muting time period can be configurable and be configured by at least one of the user of the apparatus, by the network operator, by the apparatus manufacturer and by the an application of program designer of an application which invokes or generates a mode or state.

The operation starting of the muting timer and the muting the speaker closest to the earpiece for the muting timer period is shown in FIG. 5 by step 405.

In some embodiments the acoustic shock prevention apparatus further comprises an audio ramp timer 307. The audio ramp timer 307 in some embodiments can be configured to receive an input from the apparatus state monitor 301 and also in some embodiments receive the output of the muting timer 305. In other words the apparatus can in some embodiments comprise a ramp control means for generating an audio ramp time period. In such embodiments the audio processor means for processing the audio signal can ramp the audio signal over the period defined by the ramp control means. When the audio ramp timer 307 is activated either directly from the apparatus state monitor 301 or indirectly from the audio muting timer 305 by determining an activation and subsequent deactivation of the muting timer period signal then the audio ramp timer 307 may provide an audio ramping timer input to the audio subsystem controller 309. In some embodiments the time period defined by the audio ramp timer can run concurrently with the time period defined by the muting timer 305, and the time period defined by the audio ramp timer 307 is greater than the time period defined by the muting timer 305. In some further embodiments the audio ramp timer 307 provides an audio ramping timer input to the audio subsystem controller 309 subsequent to the muting timer 305 providing the muting timing input signal.

The audio ramp time period generated by the audio ramp timer 307 can be any suitable timer period. For example as shown in FIG. 6 an audio ramp time period can be approximately 7 seconds. In some embodiments the audio ramp time period can be configurable and be configured by at least one of the user of the apparatus, by the network operator, by the apparatus manufacturer and by the an application of program designer of an application which invokes or generates a mode or state.

Furthermore in some embodiments both the muting timer 305 operations and the audio ramp timer 307 operations are implemented in a programmable single timer which is configured to indicate a start signal; an end of muting signal and an end of audio ramping signal to indicate a start to audio processing; an end of muting and an end of audio ramping respectively and thus implicitly define a muting time period and audio ramping time period.

The audio system controller 309 in some embodiments on receiving the audio ramp timer 307 signal can then apply a ramp function to the gain stage to control the audio acoustic signal generated by the speaker closest to the earpiece over the audio ramp period 407. The ramp function applied to the gain stage can be any suitable monotonically increasing function.

The operation of starting the audio ramp timer and applying the ramp function to the speaker closest to the earpiece over the audio ramp period is shown in FIG. 5 by step 407.

With respect to FIG. 6 an example of the operation of the acoustic shock prevention apparatus is shown with regards to a first and second channel acoustic signal. The first channel representation 501 which for example may be a right channel of the integrated handsfree device (which for example in FIG. 2c is the integrated handsfree speaker not adjacent to the earpiece) shows a phone call earpiece mode ending at time sample 0 and an audio signal generated using audio from the ‘incoming call’ 509 integrated handsfree alert mode approximately 2 seconds later. This integrated handsfree alert mode, if implemented at high sound pressure levels close to the earpiece, could cause acoustic shock. However as shown in the second channel representation 503 embodiments of the application mitigate or prevent acoustic shock from occurring.

With respect to the second channel representation 503 the phone call earpiece mode ends at time sample 0 505. This triggers the start of the safety timer 303, which is running during the period shown the ‘algorithm running’ label time 507. The new ‘incoming call’ integrated handsfree alert mode 509 (which can also be in other examples an audio handsfree playback, FM Radio playback over integrated handsfree, integrated handsfree speaker digital radio such as DAB (Digital Audio Broadcasting) or DRM (Digital Radio Mondiale) playback, integrated handsfree speaker amplitude modulation (AM) radio playback, video playback over integrated handsfree or any handsfree playback mode) is detected. In other words the apparatus state monitor 301 in this example determines a change in state or mode of operation of the apparatus during the safety timer period.

The change in state causes, according to this example, the apparatus state monitor 301 to activate the muting timer 305 from when the new ‘incoming call’ mode is detected at time labelled 509 for the period from when the muting timer is activated 511 to when the muting timer is deactivated 513. In the example shown in FIG. 6 the muting time period is approximately 1.5 seconds. However it would be appreciated that the muting time period is configurable to any suitable time period. This in FIG. 6 is shown as the audio signal difference between the first channel representation 501 and the second channel representation 503 for the audio signal of the incoming call alert as the integrated handsfree speaker signal is muted for the second channel representation 503 when compared to the first channel representation 501.

The time instance when the muting timing period expires 513 is then followed by the ramping timer period when there is an application of a ramping function to the audio signal closest to the earpiece when compared to the first channel. As such the application of the ramping function to the audio signal can be seen in FIG. 6 from the end of the muting period 513 to the time 515 when the volume level of the full first channel representation 501 audio signal is also seen in the second channel representation 503 audio signal. FIG. 6 the audio ramp period is approximately 7 seconds. However it would be appreciated that the audio ramp time period is configurable to be set to any suitable time period.

Thus according to some embodiments there the apparatus is capable of maintaining an acoustic continuity between changes of use cases which would reduce the possibility of acoustic shock.

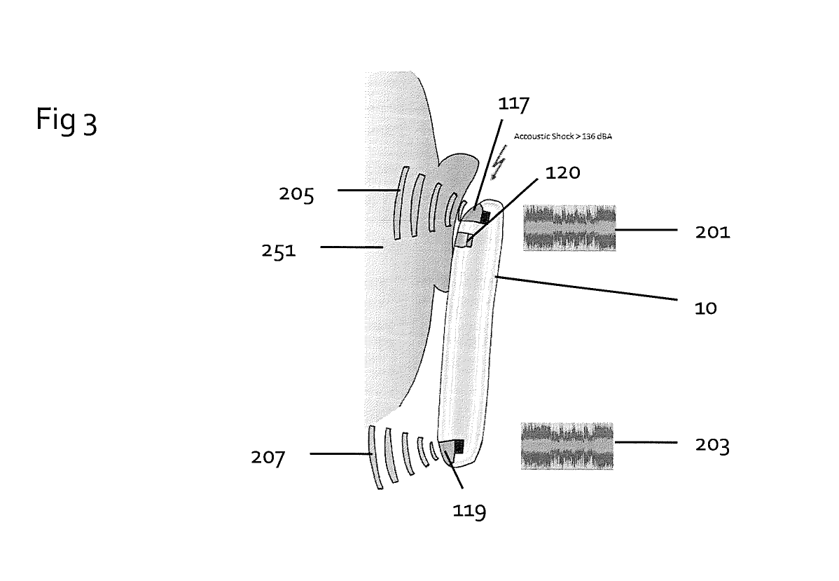

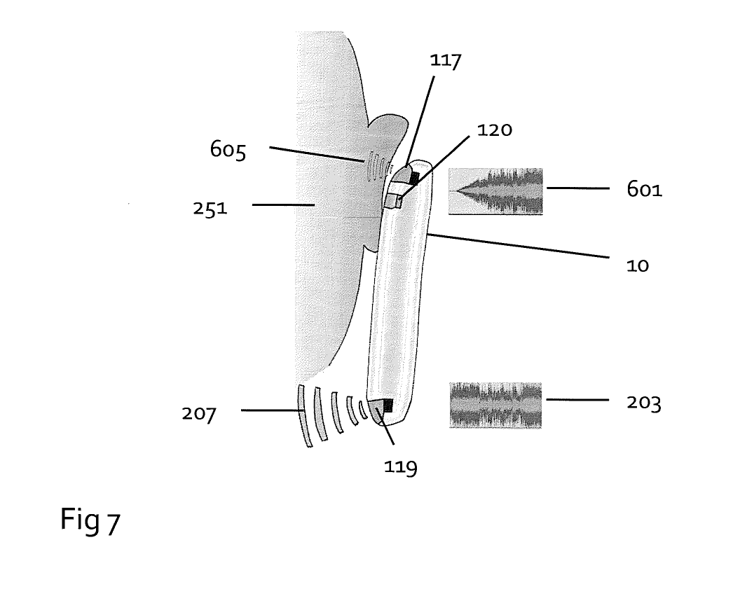

The example of the acoustic shock prevention is also shown in FIG. 7 which shows a schematic view similar to that shown in FIG. 3 except that the acoustic signal produced by the first integrated handsfree speaker 117 shown by the signal 605 is first muted and then ramped as can be seen in the waveform 601.

In some embodiments the ramping up of the audio signal from a safe level or from a muted state with a well defined increase rate allows the ramping of the volume level to a maximum of 136 dB peak/131 dBa. This in embodiments prevents acoustic shock but also enables the user to recognise the audio signal, for example an incoming phone call, resuming music or FM radio playback. Furthermore as the audio signal is ramped the user could automatically remove the phone from being close to the ear.

In some embodiments the apparatus state monitor 301 can further implement acoustic shock management based on determining the maximum sound pressure limit of the signal to be played. In other words the apparatus can in some embodiments comprise a sound pressure level estimator or sound pressure level estimator means for determining the maximum or peak value of the higher average sound pressure level. In such embodiments where the apparatus state monitor 301 determines that the maximum sound pressure limit for the incoming signal the integrated loudspeaker signal is 118 dBA then no time period is applied, in other words the phone state monitor 301 does not trigger either the muting timer or audio ramp timer and the signal output IHF mode is not modified.

In some other embodiments the apparatus state monitor 301, when detecting a maximum sound pressure limit of 125 dBA in the signal to be output on the IHF speaker, further determines if the audio signal to be output is a continuous or non-continuous signal. In these circumstances the apparatus state monitor 301 triggers the muting timer and audio ramp timer such that the muting timer is activated for both continuous and non-continuous signals. In some further embodiments the apparatus state monitor 301 furthermore for continuous signals, such as ring tones and music, does not activate the ramp timer and so the audio sub-system permits the signals to be output after the muting period at the sound pressure level which is determined by the state or mode only. For non-continuous signals such as voice the apparatus state monitor 301 can in there embodiments activate the audio ramp timer 307 which controls the audio subsystem to increase the sound pressure levels to their full value over the audio ramp time period.

Furthermore in some embodiments the apparatus state monitor 301 when determining that the maximum sound pressure level on the incoming mode signal is 136 dB peak or 131 dBA activates both the muting and audio ramp timers.

Furthermore the audio ramp timer 307 in some embodiments can be configured to send a further control signal to the audio subsystem controller 309 such that no operating mode or signal failure exceeds the 136 db peak limit and thus prevent hearing damage and/or transducer damage even after the ramp time period has expired.

Thus in summary at least one embodiment of the application performs a method comprising determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

Although the above examples describe embodiments of the invention operating within an electronic device 10 or apparatus, it would be appreciated that the invention as described below may be implemented as part of any audio processor. Thus, for example, embodiments of the invention may be implemented in an audio processor which may implement audio processing over fixed or wired communication paths.

Thus user equipment may comprise an audio processor such as those described in embodiments of the invention above.

It shall be appreciated that the term electronic device and user equipment is intended to cover any suitable type of wireless user equipment, such as mobile telephones, portable data processing devices, audio players (also known as MP3 players), media players (also known as MP4 players) or portable web browsers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus at least some embodiments may be an apparatus comprising at least one processor and at least one memory including computer program code the at least one memory and the computer program code configured to, with the at least one processor, cause the apparatus at least to perform: determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

Thus at least some embodiments may be a computer-readable medium encoded with instructions that, when executed by a computer perform: determining a change of state in an apparatus within a first time period, wherein a first state operates with a first audio output having a first average sound pressure level and a second state operates with a second audio output having a higher average sound pressure level; and processing the second audio output signal such that the second audio output sound pressure level is acoustically continuous with respect to the first average sound pressure level immediately following the change of state.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analogue and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
determining a change of state in an apparatus within a first time period, wherein a first state operates with a first audio output having a first average sound pressure level and a second state operates with a second audio output having a higher average sound pressure level; and
processing the second audio output signal such that the second audio output sound pressure level is acoustically continuous with respect to the first average sound pressure level immediately following the change of state.

2. The method as claimed in claim 1, wherein processing the second audio output signal comprises at least one of:
muting the second audio output for a muting time period; and
ramping the second audio output for an audio ramp time period.

3. The method as claimed in claim 2, wherein ramping the second audio output for an audio ramp time period comprises at least one of:
linear ramping; and
non-linear ramping.

4. The method as claimed in claim 1, wherein determining a change of state in an apparatus comprises:
determining an ending of the first state, wherein the first state is a member of a first group of states; and
determining a start of the second state, wherein the second state is a member of a second group of states.

5. The method as claimed in claim 4, wherein each member of the first group of states operate with the first audio output generated by an earpiece transducer.

6. The method as claimed in claim 4, wherein the first group of states comprise at least:
telecommunication earpiece audio playback.

7. The method as claimed in claim 4, wherein each member of the second group of states operate with the second audio output generated by an integrated handsfree transducer.

8. The method as claimed in claim 4, wherein the second group of states comprises:
integrated handsfree speaker alert tone playback;
integrated handsfree speaker music playback;
integrated handsfree speaker frequency modulation (FM) radio playback;
integrated handsfree speaker amplitute modulation (AM) radio playback;
integrated handsfree speaker digital (DRM, DAB) radio playback;
integrated handsfree speaker navigation command playback; and
integrated handsfree speaker video playback.

9. The method as claimed claim 1, further comprising:
determining the maximum value of the higher average sound pressure level is greater than a threshold value; and wherein processing the second audio output signal further comprises limiting the maximum value of the higher average sound pressure value to the threshold value.

10. The method as claimed in claim 1, wherein the second state further operates with a third audio output located physically separate from the first audio output; and p1 processing the third audio output signal such that the third audio output sound pressure level is unchanged.

11. An apparatus comprising at least one processor and at least one memory, the at least one memory and the computer program code is configured to, with the at least one processor, causes the apparatus at least to:
determine a change of state in the apparatus within a first time period, wherein a first state operates with a first audio output having a first average sound pressure level and a second state operates with a second audio output having a higher average sound pressure level; and
processing the second audio output signal such that the second audio output sound pressure level is acoustically continuous with respect to the first average sound pressure level immediately following the change of state.

12. The apparatus as claimed in claim 11, wherein causing the apparatus to process the second audio output signal cause causes the apparatus to at least one of:
mute the second audio output for a muting time period; and
ramp the second audio output for an audio ramp time period.

13. The apparatus as claimed in claim 12, wherein causing the apparatus to ramp the second audio output for an audio ramp time period causes the apparatus to at least one of:
linear ramping; and
non-linear ramping.

14. The apparatus as claimed in claim 11, wherein causing the apparatus to determine a change of state causes the apparatus at least to:
determine an ending of the first state, wherein the first state is a member of a first group of states; and
determine a start of the second state, wherein the second state is a member of a second group of states.

15. The apparatus as claimed in claim 14, wherein each member of the first group of states operate with the first audio output generated by an earpiece transducer.

16. The apparatus as claimed in claim 14, wherein the first group of states comprise at least:
telecommunication earpiece audio playback.

17. The apparatus as claimed in claim 14, wherein each member of the second group of states operate with the second audio output generated by an integrated handsfree transducer.

18. The apparatus as claimed in claim 14, wherein the second group of states comprises:
integrated handsfree speaker alert tone playback;
integrated handsfree speaker music playback;
integrated handsfree speaker frequency modulation (FM) radio playback;
integrated handsfree speaker amplitute modulation (AM) radio playback;
integrated handsfree speaker digital (DRM, DAB) radio playback;
integrated handsfree speaker navigation command playback; and
integrated handsfree speaker video playback.

19. The apparatus as claimed in claim 11, further caused to:
determine the maximum value of the higher average sound pressure level is greater than a threshold value; and wherein causing the apparatus to process the second audio output signal further causes the apparatus to limit the maximum value of the higher average sound pressure value to the threshold value.

20. The apparatus as claimed in claim 11, wherein the second state further operates with a third audio output located physically separate from the first audio output; and
the apparatus is further caused to process the third audio output signal such that the third audio output sound pressure level is unchanged.
